(19) United States
(12) Patent Application Publication
(10) Pub. No.: US 2002/0198637 A1
(43) Pub. Date: Dec. 26, 2002

(54) Car inspection system

(76) Inventor: Hiroyuki Shibata, Hyogo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/141,178

(22) Filed: May 9, 2002

(30) Foreign Application Priority Data
Jun. 20, 2001 (JP) 2001-187051

(51) Int. Cl. G06F 19/00

(52) U.S. Cl. 701/29; 340/438

(57) ABSTRACT

At the time of inspection of a car, car state data of the car to be inspected are transferred from a user-side system to a supplier-side system. In the supplier-side system, a comparison is made between the car state data and car state standard data of the car in question in a car state standard data memory which are supplied by a car supplier in advance, to thereby perform an inspection of the car. The car state inspection result is transferred to the user-side system and is outputted to the user terminal. In this manner, a car inspection system capable of timely diagnosis in response to a demand for diagnosing is obtained while preventing the system from becoming large in size as well as in cost of construction.

### BACKGROUND OF THE INVENTION

1. Field of the Invention

The present invention relates to a car inspection system which electronically performs an online inspection of an automotive vehicle (hereinafter called “a car” for simplicity).

2. Description of the Prior Art

FIG. 12 is a block diagram showing an arrangement of an example of a conventional car inspection system. In the figure, reference numeral 1 denotes a car to be inspected. Reference numeral 2 is a diagnosing (or inspecting) site which is outside the car 1. Inside the car 1, reference numeral 3 is a detecting means for detecting information on the car, reference numeral 4 is a memory means for holding the detected car information, reference numeral 5 is a transmitting means for transmitting the car information to the diagnosing site, reference numeral 6 is a receiving means for receiving a diagnosing information from the diagnosing site 2, and reference numeral 7 is an output means for outputting the received diagnosing information. Reference numeral 8 is a diagnosing means which is provided in the diagnosing site and which diagnoses the car 1 based on the car information from the car 1.

A description will now be made about the operation.

Inside the car 1, the car information such as the car driving information or the like is detected by the detecting means 3, stores it in the memory means 4, and is wirelessly transmitted to the diagnosing site 2 outside the car through the transmitting means 5. In the diagnosing site 2, the diagnosing of the troubles (or fault diagnosing) in the car 1 is performed in situ by means of the large-size diagnosing means 8 which is disposed therein. The diagnosing information obtained by this fault diagnosing is transmitted from the diagnosing site 2 to the car 1 and is received by the receiving means 6 for outputting to the outputting means 7. This kind of car inspection system is disclosed in JP-A 6-102148 (1994).

Further, in JP-A 2000-289583 or the like, there is disclosed the car inspection system in which the diagnosed information of the car 1 is sent from the car 1 to the diagnosing site 2 outside the car 1, and a diagnosing routine to be determined by the past diagnosing history is downloaded into the car 1. Also in this car inspection system, its general functional arrangement is similar to that shown in FIG. 12.

Still furthermore, in JP-A 10-194095 (1998), 60-222337 (1985) or the like, there is disclosed a car inspection system in which the car information such as the driving information or the like of the car 1 is numerically represented by each piece of equipment inside the car 1 during driving or operation of the car 1, and is sent to the diagnosing site 2 outside the car 1, whereby the diagnosing of the car 1 is performed. Also in these car inspection systems, the functional arrangement of the car inspection system is similar to that shown in FIG. 12.

Since the conventional car inspection system is arranged as described above, there are the following problems. Namely, there is required the large-scale diagnosing means 8 for performing the processing by a car diagnosing software or for performing a routine diagnosing control or the like at the diagnosing site 2 outside the car 1. Further, the diagnosing treatment must be prepared for each kind of the car 1. As a result, a large amount of time is required in upgrading the version of the diagnosing software, and the cost of system construction increases. Due to the factors of cost increase and the control, or the like, the number of the diagnosing sites 2 must be limited. If the number of the diagnosing sites 2 is small, it will be difficult for each of the diagnosing sites 2 to timely treat the diagnosing demand from each of the cars 1 even by using a large-scale system network such as the Internet, resulting in the necessity of constructing a diagnosing system of a larger scale.

### SUMMARY OF THE INVENTION

This invention has been made to solve the above-described problems and has an object of providing a car inspection system in which the cost for system construction is kept low and in which the diagnosing is timely treated in response to the diagnosing demand.

In order to attain the above and other objects, the present invention provides a car inspection system comprising a user-side system and a supplier-side system. The user-side system comprises: a first car state data holding means for holding car vehicle state data of a car to be inspected; a first car state inspection result holding means for holding a car inspection result of the car; wherein, upon receipt of a demand for inspection of the car, the user-side system stores the car state data in the first car state data holding means, transfers the demand for inspection together with the car state data held in the first car state data holding means, and outputs the car state inspection result held in the car state inspection result holding means.

The supplier-side system comprises: a second car state data holding means for holding the car state data transferred from the user-side system; a car state standard data memory means for storing car state standard data with which is compared the car state data transferred from the user-side system; a car inspection means for controlling the inspection of the car by comparing the car state data held by the second car state data memory means with the car state standard data stored in the car state standard data memory means; a second car state inspection result holding means for holding the car inspection result by the car inspection means, wherein, upon receipt of a demand for inspection from the user-side system, the supplier-side system starts the car state inspection means to compare the car state data with the car state standard data, holds the car state inspection result in the second car state inspection result holding means, and transmits the car state inspection result held by the second car state inspection result holding means to the user-side system.

When the car state inspection result in the supplier-side system has an abnormality, a treatment method to cope with the abnormality is transferred to the user-side system and is outputted thereto.

If there are a plurality of treatment methods to cope with the abnormality, a desired treatment method is selected therefrom and is transferred to the supplier-side system.

A parts list of a part required for the repair according to the treatment method selected by the supplier-side system is prepared and is transferred to the user-side system for outputting thereto.

From the parts list received by the user-side system, selection is made of the part which is desired to be used, and data on the selected part are transferred to the supplier-side system.

A list is made of repair shops which are capable of performing the repair according to the treatment method selected by the supplier-side system, and is transferred to the user-side system for outputting thereto.

The user-side system designates a repair shop that is capable of performing the repair according to the treatment method selected by the supplier-side system, and an order for performing the repair is placed with the designated repair shop.

Personal treatment history data based on the inspection result, treatment method, or the like are transferred from the supplier-side system to the user-side system for holding them therein so that they may be referred to where necessary.

That replacement time of parts which is supplied by parts manufacturers is compared with a period of service of a part which is in use in the car to be inspected. Then, a list of part which is already due to be replaced is prepared for transferring to the user-side system.

### BRIEF DESCRIPTION OF THE DRAWINGS

The above and other objects and the attendant advantages of the present invention will become readily apparent by reference to the following detailed description when considered in conjunction with the accompanying drawings wherein:

FIG. 1 is a block diagram showing an arrangement of a car state inspection system according to embodiment 1 of this invention;

FIG. 2 is a flow chart showing an operation of the car inspection system in embodiment 1;

FIG. 3 is an explanation diagram showing an arrangement of data in car state data in embodiment 1:

FIG. 4 is an explanation diagram showing an arrangement of data in car state standard data in embodiment 1;

FIG. 5 is a block diagram showing an arrangement of the car inspection system according to embodiment 2 of this invention;

FIG. 6 is a block diagram showing an arrangement of the car inspection system according to embodiment 3 of this invention;

FIG.7 is a block diagram showing an arrangement of the car inspection system according to embodiment 4 of this invention;

FIG. 8 is a block diagram showing an arrangement of the car inspection system according to embodiment 5 of this invention;

FIG. 9 is a block diagram showing an arrangement of the car inspection system according to embodiment 6 of this. invention;

FIG. 10 is a block diagram showing an arrangement of the car inspection system according to embodiment 7 of this invention;

FIG. 11 is a block diagram showing an arrangement of the car inspection system according to embodiment 6 of this invention; and

FIG. 12 is a block diagram showing an arrangement of a conventional car inspection system.

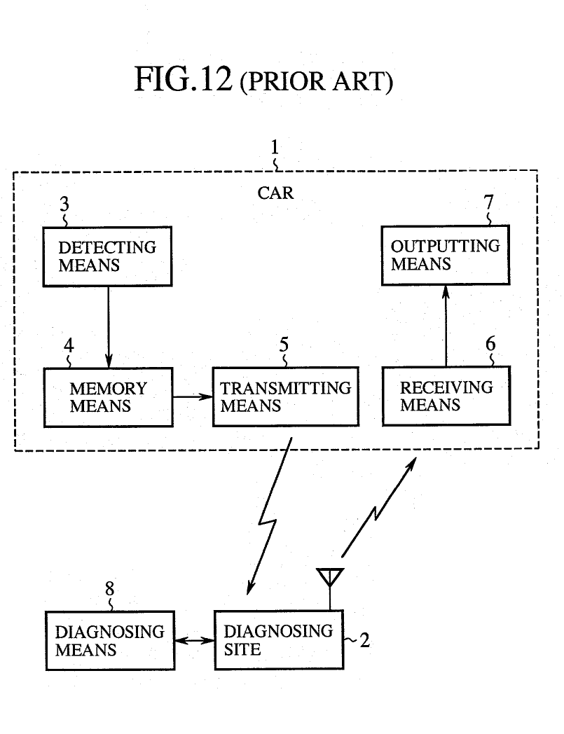

### DETAILED DESCRIPTION OF THE PREFERRED EMBODIMENTS

An embodiment of the present invention will be described below.

Embodiment 1

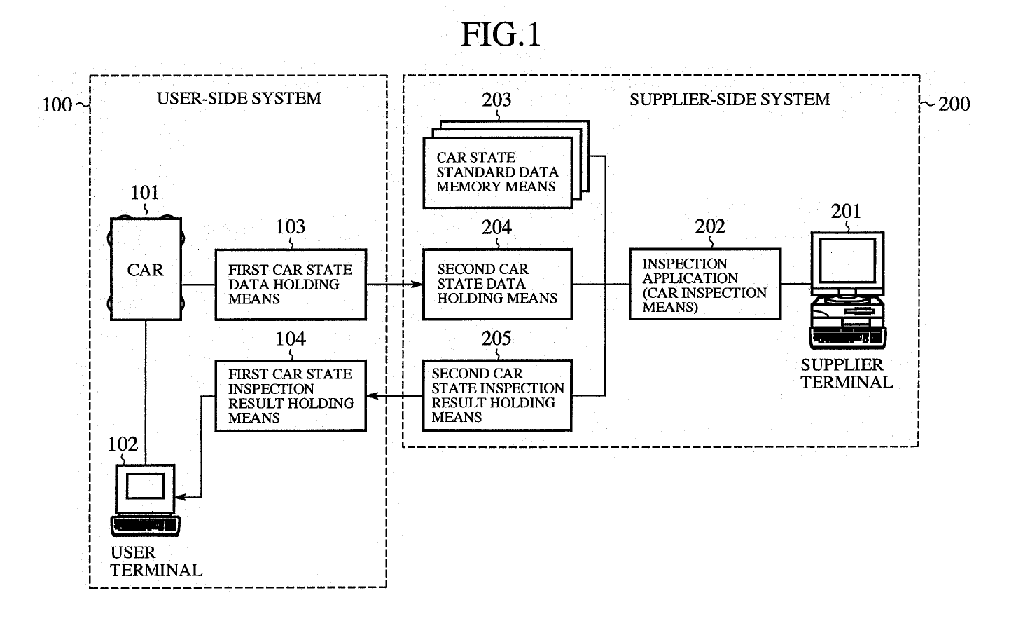

FIG. 1 is a block diagram showing an arrangement of a car inspection system according to embodiment 1 of this invention. In the figure, reference numeral 100 is a user-side system which demands the inspection of a car. Reference numeral 200 is a supplier-side system which transmits the inspection result of the car to the user system 100. Inside the user-side system 100, reference numeral 101 is a car which is the object of inspection by the car inspection system, and reference numeral 102 is a user terminal in the form of a personal computer (PC) or the like which performs communication with the supplier-side system 200 and starts up various application programs. Reference numeral 103 is a car state data holding means which once holds the car state data of the car 101 (data showing the state of each internal equipment of the car 101) and then transfers them to the supplier-side system 200. Reference numeral 104 is a car state inspection result holding means which receives and holds the car state inspection result of the car 101 by the supplier-side system 200 based on the car state data.

Inside the supplier-side system 200, reference numeral 201 is a supplier terminal in the form of a PC or the like which performs communication with the user-side system 100 and starts up various application programs. Reference numeral 202 is an inspection application as a car inspection means for controlling the inspection of the car 101 in the user-side system 100. Reference numeral 203 is a car state standard data memory means which stores, for each kind of car, car state standard data which are data of the car under normal state thereof delivered in advance from a car supplier. Reference numeral 204 is a car state data holding means which receives and once holds the car state data of the car 101 to be inspected, from the car state data holding means 103 in the user-side system 100. Reference numeral 205 is a car state inspection result holding means which once holds the result of comparison between the car state standard data and the car state data as the car state inspection result and then transfers it to the car state inspection result holding means 104.

A description will now be made about the operation.

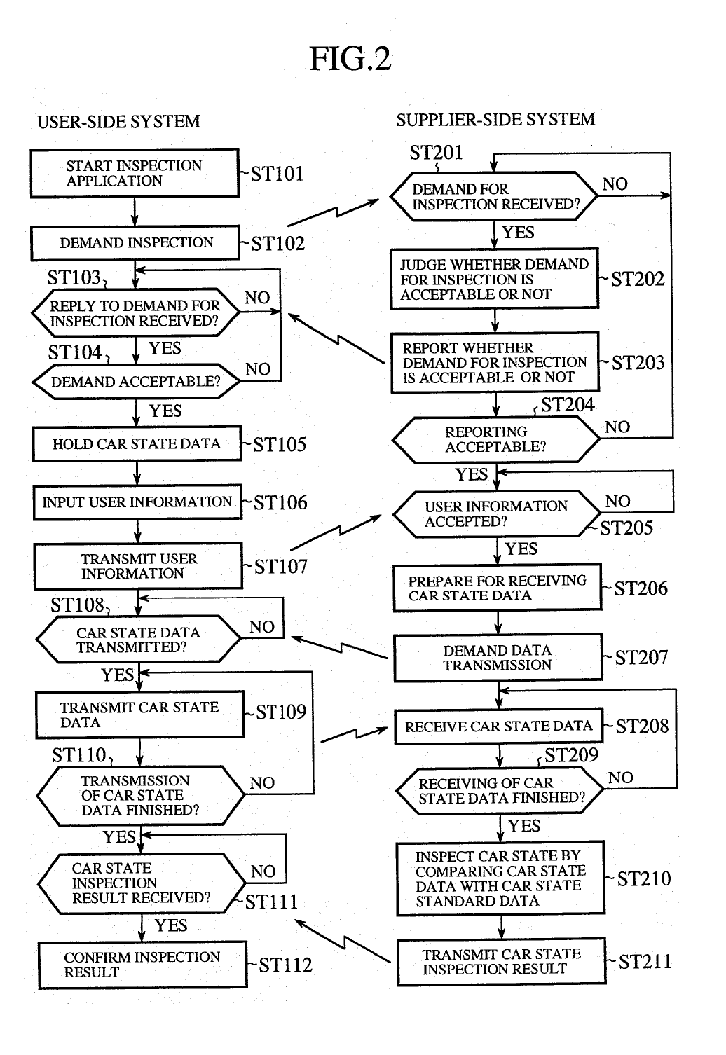

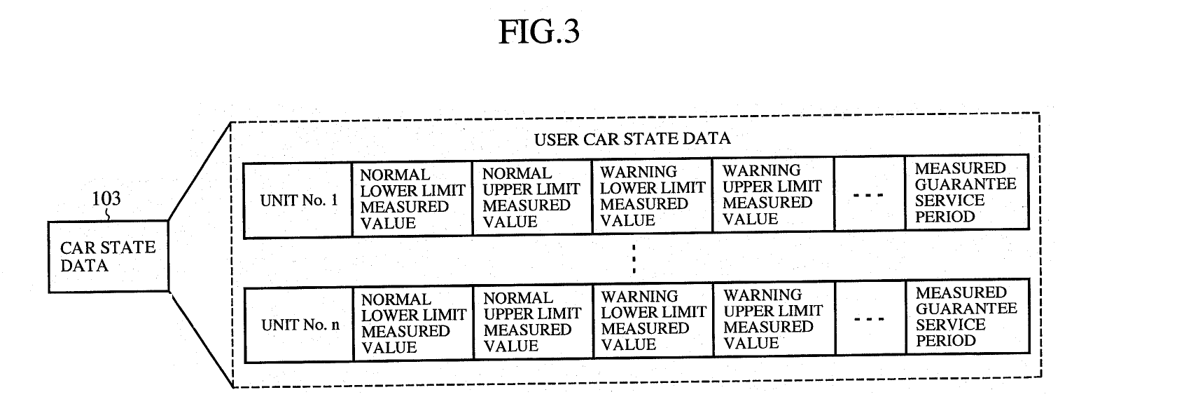

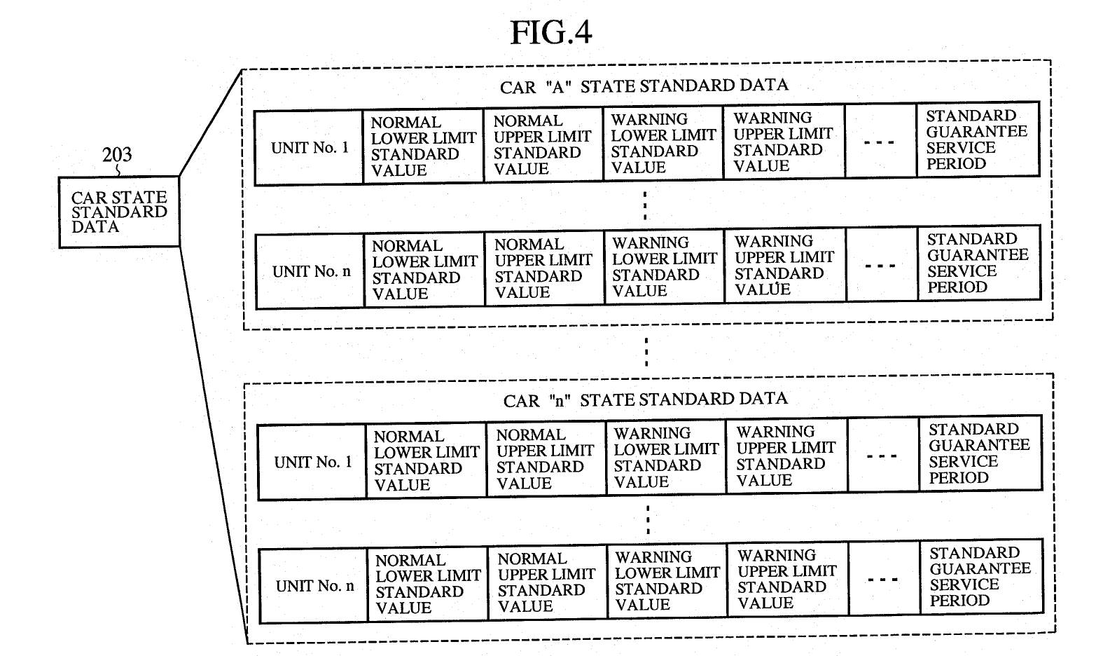

FIG. 2 is a flow chart showing the operating procedure of the car inspection system according to embodiment 1. FIG. 3 is an explanation diagram showing the data arrangement of the car state data held in the car state data holding means 204. FIG. 4 is an explanation diagram showing the data arrangement of the car state standard data stored in the car state standard data memory means 203. A description will now be made with reference to these figures.

When an inspection of a car is desired, an inspector connects the user terminal 102 to the car 101 to be inspected to thereby start up the inspection application (step ST101). The user-side system 100 having received a demand for inspection of the car 101 makes an access to the supplier-side system 200 through the Internet and sends out the demand for inspection (step ST102). The supplier-side system 200 keeps on monitoring the receiving of a demand for inspection (step ST201). If there is a demand for inspection from the user-side system 100, the state of receiving demands from user-side systems other than the user-side system 100 in question is checked, and a judgement is made as to whether the demand for inspection may be accepted or not (step ST202). The result of this judgement as to whether the demand for inspection may be accepted or not is reported from the supplier-side system 200 to the user-side system 100 that has attempted an access to the supplier-side system 200 (step ST203).

After having sent out the demand for inspection at step ST102, the user-side system 100 is in a standby state to wait for reception of a reply to the demand for inspection (step ST103). If the reply to the demand for inspection has been received, a judgement is made as to whether the demand is acceptable or not (step ST104). If the received reply to the demand for inspection is not acceptable, the procedure is returned to step ST103 to thereby become a standby state to wait for the reception of a reply to the demand for inspection. On the other hand, if the reply to the demand for inspection is “acceptable,” the car state data of the car 101 to be inspected are detected in the user-side system 100 and are once held in the car state data holding means 103 (step ST105). As shown in FIG. 3, the car state data are made up, for each unit of the cars 101 to be inspected, of the unit number, a normal lower limit measured value, a normal upper limit measured value, a warning lower limit measured value, a warning upper limit measured value, . . . , a measured guarantee service period.

After having reported at step ST203 to the user-side system 100 whether the demand for inspection may be accepted or not, the supplier-side system 200 checks whether the reporting was acceptable or not (step ST204). As a result, if the reporting is not acceptable, the procedure is returned to step ST201 and the above-described series of operations are repeated. If the reporting is acceptable, on the other hand, the supplier-side system 200 will be in a standby state to wait for the reception of the user information from the user-side system 100 (step ST205). If the received reply of acceptance is judged to be acceptable at step ST104, the user-side system 100 inputs, as the user information, car discriminating conditions such as the kind, grade, year, options that have been set, or the like (step ST106), and the user information is transmitted to the supplier-side system 200 through the Internet (step ST107).

In the supplier-side system 200, upon confirmation at step ST205 of the reception of the user information from the user-side system 100, the inspection application 202 is started up to thereby make a preparation for the reception of the car state data (step ST206). In this preparation for the reception of the car state data, the car state standard data for the inspection of the car 101 are selected from the contents of the car state standard data memory means 203 according to the car discrimination condition in the user information transmitted from the user-side system 100. As shown in FIG. 4, the car state standard data are made up, for each kind A, . . . , n of the cars to be supplied by the supplier, of the unit number, normal lower limit standard value, normal upper limit standard value, warning lower limit standard value, warning upper limit standard value, . . . standard guarantee service period, for each unit.

After having transmitted the user information, the user-side system 100 will be in a state to wait for permission to transmit the car state data and will be in a standby state until the reception of the data transmission demand to be made at step ST207 from the supplier-side system 200 (step ST108). When the data transmission demand is received from the supplier-side system 200, that car state data of the car to be inspected which are temporarily held in the car state data. holding means 103 are sequentially transmitted to the supplier-side system 200 (step ST109). Thereafter, monitoring is made to see whether the transmission of all of the car state data has been finished or not (step ST110). If the transmission has not been finished, the procedure returns to step ST109 to continue the transmission of the car state data until the transmission is finished.

In the supplier-side system 200, the car state data from the user-side system 100 are received and are sequentially held in the car state data holding means 204 (step ST208). Monitoring is made in the supplier-side system 200 to see whether the receiving of the car state data has been finished or not (step ST209). If the receiving has not been finished, the procedure returns to step ST208 and the receiving of the car state data from the user-side system 100 is continued until it is finished.

In the supplier-side system 200, if all of the car state data have been received, there is made at step ST206 a comparison in the inspection application 202 between the car state standard data of the corresponding kind selected from the car state standard data memory means 203 and those car state data of the car 101 to be inspected which are received at step ST208 to thereby inspect the car state of the car 101 (step ST210). In this step ST210, a comparison is made, for each of the corresponding units of the car 101, to see whether a normal lower limit measured value is within the normal lower limit standard value, or whether a normal upper limit measured value is within the normal upper limit standard value, or whether a warning lower limit measured value is within the warning lower limit standard value, and so on. The result of comparison is held in the car state inspection result holding means 205 as the car state inspection result.

The supplier-side system 200 transmits the car state inspection result held in the car state inspection result holding means 205 to the user-side system 100 through the Internet (step ST211). The user-side system 100 then monitors the car state inspection result (step ST111) and repeats the processing at step ST111 until the car state inspection result is received. When the car state inspection result is received, the user-side system 100 once stores the car state inspection result in the car state inspection result holding means 104 and then transmits it to the user terminal 102 for outputting thereto (step ST112). The person who demands the inspection (the user) refers to the car state inspection result to be outputted to the user terminal 102, whereby he or she can immediately know the abnormalities of the car 101 to be inspected.

As described above, according to embodiment 1, the car state data of the car 101 to be inspected are transmitted from the user-side system 100 to the supplier-side system 200, and are compared with the car state standard data of the corresponding kind of car, whereby the inspection of the car 101 is performed. Therefore, there is an effect in that it becomes possible to perform an online car inspection when the car 101 is desired to be inspected, by making an access from the user-side system 100 to the supplier-side system 200 through the Internet and that the diagnosing treatment can be timely performed in reply to the diagnosing demand while preventing the car inspection system from becoming large in size.

Embodiment 2

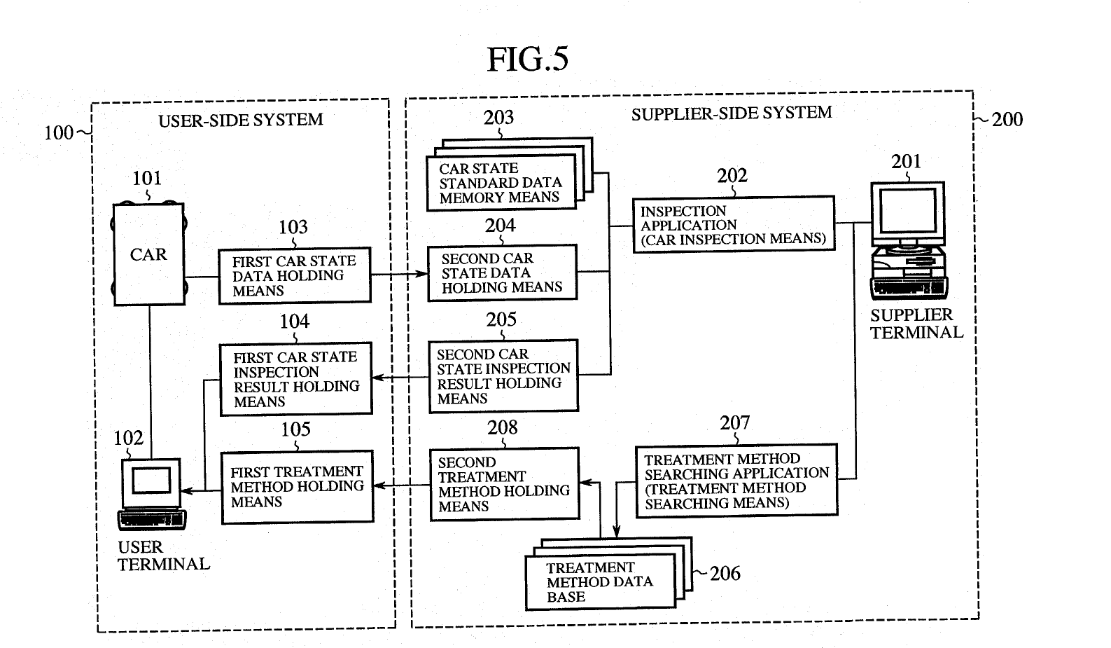

FIG. 5 is a block diagram showing an arrangement of a car inspection system according to embodiment 2 of this invention. In the figure, reference numeral 101 is a car to be inspected, reference numeral 102 is a user terminal, reference numeral 103 is a car state data holding means, reference numeral 104 is a car state inspection result holding means, reference numeral 202 is an inspection application as a car inspection means, and reference numeral 203 is a car state standard data memory means, reference numeral 204 is a car state data holding means, reference numeral 205 is a car state inspection result holding means. The above-described elements are the same as those shown in FIG. 1 with the same reference numerals. The user-side system 100 and the supplier-side system 200 in this embodiment 2 are different from those in embodiment 1 in that they are provided with the following elements.

Namely, in the supplier-side system 200, there is provided a treatment method data base 206 which stores in memory a treatment method supplied in advance by the car supplier. This treatment method data base 206 is prepared for each of the car state inspection result in comparison, in the inspection application 202, between the car state standard data in the car state standard data memory means 203 and the car state data in the car state data holding means 204. The supplier-side system 200 is further provided with a treatment method searching application 207 as a treatment method searching means which searches the treatment method data base according to the result of the car state inspection by the inspection application 202 and selects a treatment method. The selected treatment method is once held in a treatment method holding means 208 which then transfers the selected treatment method to the user-side system 100. The user-side system 100 is further provided with a treatment method holding means 105 which receives the treatment method from the treatment method holding means 208 in the supplier-side system 200 and once holds it therein.

A description will now be given of the operation.

The operations from the time in which the car state inspection result of the car 101 by the inspection application 202 in the supplier system 200 is sent to the user-side system 100 to the time in which it is outputted to the user terminal 102 are the same as those in embodiment 1. If the car state inspection result is found to be abnormal, the treatment method searching application 207 is started up. If the treatment method searching application 207 is started up, the treatment method data base 206 is searched according to the car state search result in the inspection application 202 to thereby select a treatment method which suits the car state inspection result. This treatment method may include the portions to be treated (repaired and/or replaced), contents of repairs, and approximate values of treatment costs. A plurality of treatment methods are sometimes present depending on the level of treatment.

In the supplier-side system 200, the treatment method selected by the treatment method searching application 207 is sent to the treatment method holding means 208 for being held therein and is also transmitted to the user-side system 100 through the Internet. In the user-side system 100, the transmitted treatment method is once held in the treatment method holding means 105 and is transmitted to the user terminal 102 for outputting thereto. The person demanding the inspection (i.e., the user) refers to the treatment method thus outputted to the user terminal 102 and grasps the treatment method to cope with the abnormality in the car 101 to be inspected.

As described herein above, according to embodiment 2, when there is an abnormality in the car inspection result, the treatment method is notified from the supplier-side system 200 to the user-side system 100. Therefore, there is an effect in that the person demanding the inspection is able to know immediately the car state inspection result and the treatment method to deal with the abnormality and that he or she can recognize the time and cost required for the treatment.

Embodiment 3

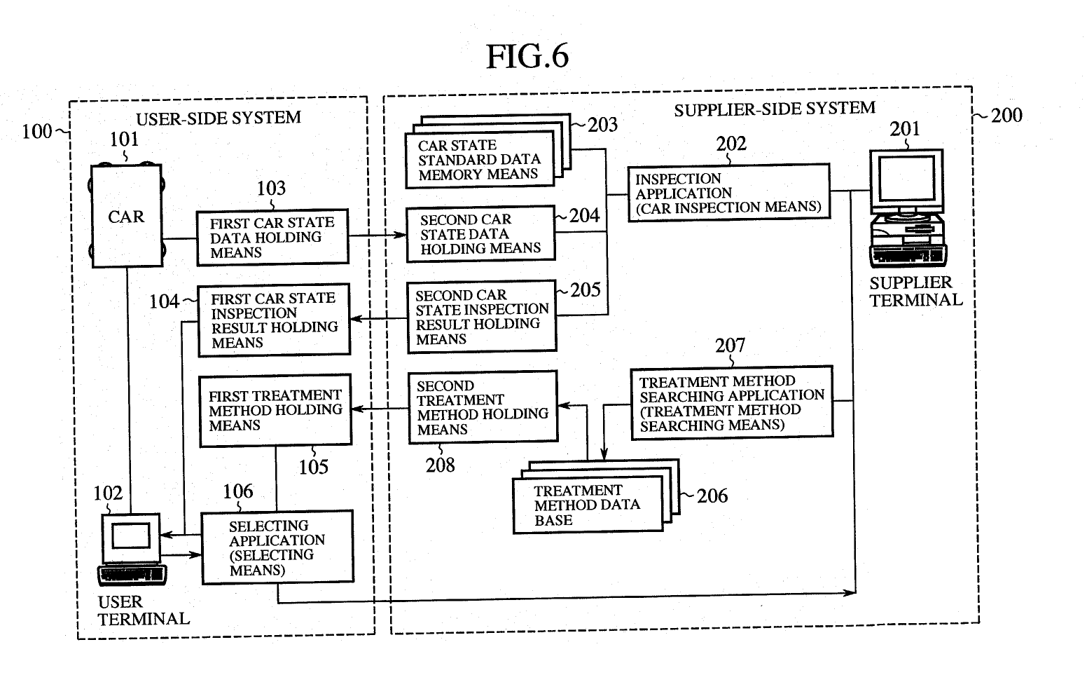

FIG. 6 is a block diagram showing an arrangement of the car inspection system according to embodiment 3 of this invention. The same reference numerals as those in FIG. 5 have been assigned to the corresponding portions and their explanations are omitted. In the figure, reference numeral 106 is a selecting application as a selecting means which is disposed inside the user-side system 100. This selecting application 106 selects a treating method which is desired by the person demanding the inspection (user) out of the treatment methods transferred from the supplier-side system 200 and are temporarily held in the treatment method holding means 105.

A description will now be made about the operation.

When an abnormality has been found in the car state inspection result of the car 101 by the inspection application 202, the basic operations up to the time in which the treatment method is notified from the supplier-side system 200 to the user-side system 100 are the same as those described with reference to embodiment 2. Therefore, the description thereabout are omitted here. Instead, a description will be made about a newly added selecting application 106.

In the notification of the treatment method to the user-side system 100, if there exist a plurality of treatment methods which are transferred from the supplier-side system 200, the selecting application 106 outputs to the user terminal 102 all of the treatment methods that are stored in the treatment method holding means 105. The person demanding the inspection refers to the treatment methods outputted to the user terminal 102 and selects by the selecting application 106 a desired treatment method based on the level, features, or the like of the respective methods. The treatment method selected by this selecting application 106 is transferred from the user-side system 100 to the supplier-side system 200 through the Internet.

As described above, according to embodiment 3, when there exist a plurality of treatment methods, the desired treatment method is selected by the selecting application 106 and is transferred to the supplier-side system 200. Therefore, there is an effect in that it becomes possible also for the person demanding the inspection (user) to know the treatment methods that only the inspector was so far able to know, and also that it becomes possible for him or her to select a desired treatment method depending on the treatment methods, approximate treatment costs or the like. As a result, he or she can recognize, within a predetermined range, the time and cost which vary with the treatment level.

Embodiment 4

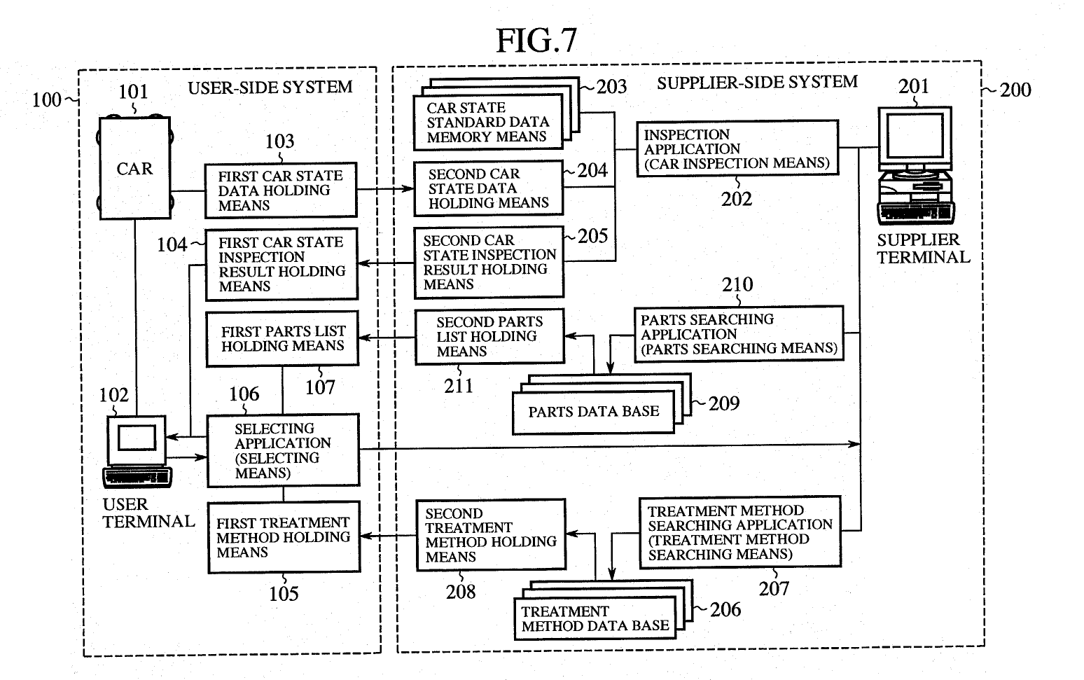

FIG. 7 is a block diagram showing an arrangement of a car inspection system according to embodiment 4 of this invention. The corresponding portions have been assigned the same reference numerals as those in FIG. 6 and their explanations are omitted. In the figure, reference numeral 209 is a parts data base which holds in memory the data of the -parts required in each of the treatment methods and which is delivered in advance from the car supplier. Reference numeral 210 is a parts searching application as a parts searching means which receives the treatment method to be transferred from the user-side system 100 and searches, in accordance with the contents of the treatment method, the parts list data base 209 to thereby prepare a parts list of the required parts. Reference numeral 211 is a parts list holding means which holds the parts list selected by the parts searching application 210, and transfers it to the supplier-side system 100.

Reference numeral 107 is that parts list holding means of the user-side system 100 which once holds the parts list to be transferred from the parts list holding means 211 in the supplier-side system 200. Reference numeral 106 is a selecting application as a selecting means for selecting the treatment method desired by the person demanding the inspection (i.e., the user) out of the treatment methods which are transferred from the supplier-side system 200 and which are temporarily held in the treatment method holding means 105. The selecting application 106 also selects the parts list desired by the person demanding the inspection out of the parts list held in the parts list holding means 107, and transfers the selected parts list to the supplier-side system 200.

A description will now be given of the operation.

When a plurality of treatment methods are present to deal with the abnormality in the car state inspection result of the car 101, the basic operations up to the time in which a desired treatment method is selected by the selecting application 106 and then transfers it to the supplier-side system 200 are similar to those as explained in embodiment 3. Therefore, the explanation thereabout are omitted. Instead, a description of operation will be made mainly about the preparation of a parts list by the parts searching application 210 and the selection of parts list by the selecting application 106.

When there exist a plurality of treatment methods to be transferred from the supplier-side system 200 to the user-side system 100, the selecting application 106 selects a treatment method desired by the person demanding the inspection and then transfers it to the supplier-side system 200 through the Internet. The treatment method sent from the selecting application 106 of the user-side system 100 to the supplier-side system 200 is transferred to the parts searching application 210. The parts searching application 210 searches, in the parts data base 209, data of parts to be used in the treatment method desired by the person demanding the inspection, and prepares a parts list. The parts list prepared by this parts searching application 210 is once held in the parts list holding means 211, and the contents thereof are transferred to the user-side system 100 through the Internet.

The user-side system 100 sends the parts list received from the supplier-side system 200 to the parts list holding means 107 and once holds it therein. According to this operation, there is held in the parts list holding means 107 in the user-side system 100 a parts list necessary for the treatment method desired by the person demanding the inspection. The parts list to be transferred from the supplier-side system 200 to the user-side system 100 is not always limited to one in kind; there are cases where a plurality of parts lists are prepared. The parts list held in this parts list holding means 107 is outputted by the selecting application 106 to the user terminal 102 and informs the person demanding the inspection of the required parts.

In case there exist a plurality of parts lists transferred from the supplier-side system 200 to the user-side system 100, the selecting application 106 outputs all of the parts list to the user terminal 102. The person demanding the inspection refers to these plural kinds of part lists outputted to the user terminal 102 and, based on the price, performance or the like of the parts to be used, selects a desired parts list by the selecting application 106. The selected parts list is notified by the user-side system 100 to the supplier-side system 200 through the Internet.

As described above, according to embodiment 4 the parts list to be used in the desired treatment method is sent from the supplier-side system 200 to the user-side system 100 and is outputted to the user terminal 102. Therefore, there can be obtained an advantage in that the person demanding the inspection is able to know immediately the parts required for the treatment, and also to recognize the outline of the cost of the parts. Further, since the parts list sent to the supplier-side system 200 is selected by the selecting application 106, there can be obtained an effect in that the parts that only the inspector was so far able to select can also be selected on the part of the person demanding the inspection (user). Further, since the selection of the parts to be used can be made also from the viewpoint of the cost of the parts, it becomes possible to confirm those costs other than the treatment cost which vary with the parts to be used.

Embodiment 5

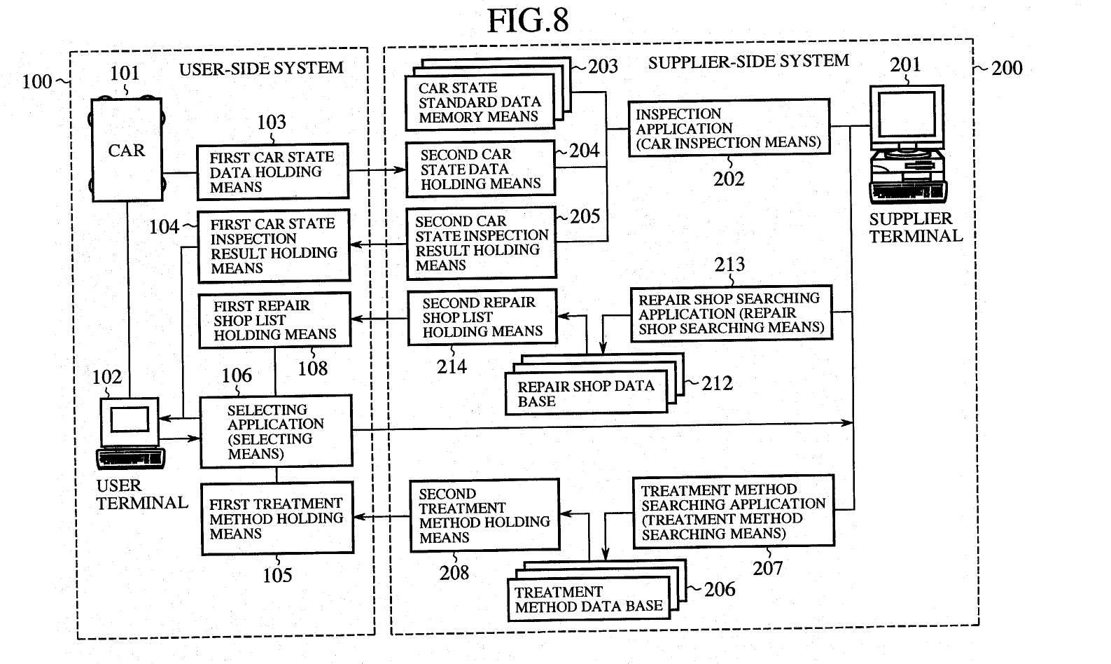

FIG. 8 is a block diagram showing an arrangement of the car inspection system according to embodiment 5 of this invention. The corresponding portions have been assigned the same reference numerals as those in FIG. 6 and their explanations are omitted. In the figure, reference numeral 212 is a repair shop data base which is delivered in advance from the car supplier. This data base holds in memory the data, for each of the repair methods, of the repair shops which are capable of performing the repair by the repair method in question. Reference numeral 213 is a repair shop searching application as a repair shop searching means which receives the treatment method transferred from the user-side system 100, searches the repair shop data base 212 according to the contents of the treatment method, and prepares a list of a repair shop capable of performing the repair in question. Reference numeral 214 is a repair shop list holding means which holds the list of repair shops selected by the repair shop searching application 213 and which transfers the list to the user-side system 100.

Reference numeral 108 is that repair shop list holding means of the user-side system 100 which once holds the repair shop list to be sent from the repair shop list holding means 214 in the supplier-side system 200.

A description will now be made about the operation.

When there exist a plurality of treatment methods to deal with the abnormalities in the car state inspection result of the car 101, the basic operations from the time in which the desired treatment method is selected by the selecting application 106 to the time in which the selected method is transferred to the supplier-side system 200 are similar to those as explained in embodiment 3. Therefore, their explanations are omitted here. Instead, a description will be made mainly about the operations of preparing the repair shop list by the repair shop searching application 213 and of selecting the repair shop list by the selecting application 106.

In case there exist a plurality of treatment methods which are transferred from the supplier-side system 200 to the user-side system 100, the selecting application 106 selects a treatment method desired by the person demanding the inspection, and transmits it to the supplier-side system 200 through the Internet. The treatment method thus transferred from the selecting application 106 of the user-side system 100 to the supplier-side system 200 is sent to the repair shop searching application 213 from the treatment method searching application 207. The repair shop searching application 213 searches, from the repair shop data base 212, the data of the repair shop that can perform the treatment method desired by the person demanding the inspection, prepares a list of repair shop, and then once holds the prepared list in the repair shop list holding means 214. The contents of this repair shop list holding means 214 are transferred to the user-side system 100 through the Internet.

In the user-side system 100, the repair shop list from the supplier-side system 200 is once held in the repair shop list holding means 108. As a result, in the repair shop list holding means 108 in the user-side system 100, there is held the list of repair shop that can perform the treatment method desired by the person demanding the inspection. The repair shop list held in the repair shop list holding means 108 is outputted to the user terminal 102 by the selecting application 106. The repair shop that can perform the desired treatment method is notified to the person demanding the inspection.

As described above, according to embodiment 5, the list of the repair shop that can perform the repair according to the desired treatment method is sent from the supplier-side system 200 to the user-side system 100 and is then outputted to the user terminal 102. Therefore, there is an effect in that, by referring to the user terminal 102, the person demanding the inspection can immediately know the repair shop with which an order can be placed.

Embodiment 6

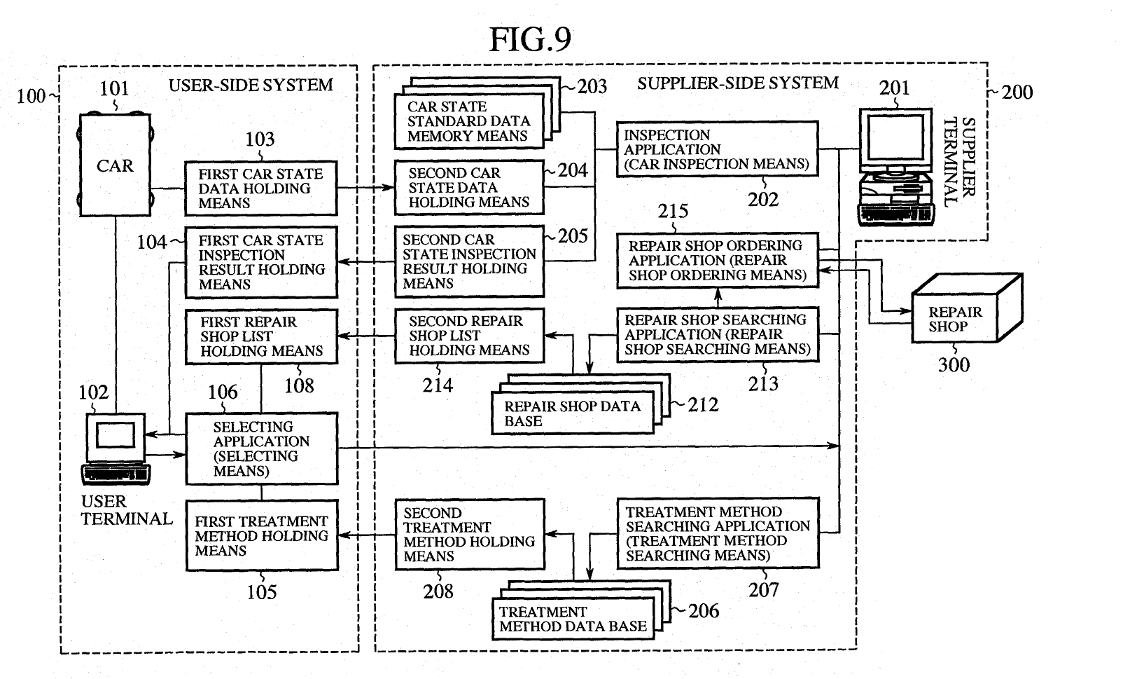

FIG. 9 is a block diagram showing an arrangement of the car state inspection system according to embodiment 6 of this invention. The corresponding portions have been assigned the same reference numerals as those in FIG. 8 and their explanations are omitted. In the figure, reference numeral 300 is a repair shop to perform the repairing of the car 101. Here, only one representative repair shop is illustrated. Reference numeral 106 is a selecting application as a selecting means which is different from that with the same reference numeral as illustrated in FIG. 8 in the following points. Namely, out of the treatment methods which are transferred from the supplier-side system 200 and are temporarily held in the treatment method holding means 105, the treatment method desired by the person demanding the inspection (user) is selected and is transferred to the supplier-side system 200 and, the repair shop 300 with which the person demanding the inspection desires to place an order is selected from the repair shop list held in the repair shop list holding means 108, and is transferred to the supplier-side system 200. Reference numeral 215 is a repair shop ordering application as repair shop ordering means for placing an order with the repair shop 300 which is desired by the person demanding the inspection and which is sent from the selecting application 106.

A description will now be given of the operation.

When there exist a plurality of treatment methods to deal with the abnormalities in the car state inspection result of the car 101, the basic operations from the time in which the desired treatment method is selected in the selecting application 106 to the time in which the list of repair shop capable of performing the repair in the selected treatment method is transferred to the user-side system 100 are similar to those as explained in embodiment 5. Therefore, their explanations are omitted here. Instead, a description will be made mainly about the operations of placing an order with the repair shop 300 by the repair shop ordering application 215 that has been added in this embodiment.

The list of repair shop capable of performing the repairing according to the treatment method desired by the person demanding the inspection is searched by the repair shop searching application 213 and is transferred from the supplier-side system 200 to the user-side system 100 through the Internet. In the user-side system 100, the repair shop list from the supplier-side system 200 is once held in the repair shop list holding means 108, and the list is outputted to the user terminal 102 to thereby inform the person demanding the inspection.

In case a repair shop with which an order is desired to be placed is selected in the user-side system 100 from the repair shop list outputted to the user terminal 102, the person demanding the inspection is required to make a selection as to whether an order for repairing shall also be placed with that repair shop. The information about the repair shop with which the order is desired to be placed, as well as the information about the presence or absence of an order placed with the repair shop in question are transferred from the user-side system 100 to the supplier-side system 200 through the Internet. In the supplier-side system 200, the repair shop ordering application 215 receives from the repair shop searching application 213 the information about the repair shop with which the order is desired to be placed as well as the information about the presence or absence of an overlapped order (or orders) placed with the repair shop. Based on the information about the presence or absence of the overlapped order placed with the repair shop in question, a judgement is made as to whether an order shall be placed with the designated repair shop or not.

If a judgement is made that there “is another order (or other orders) placed in an overlapped manner, ” the personal information, the car state, and the inspection result picked up in the repair shop searching application 213 are handed over to the repair shop application 215. An order for repairing the car 101 is then placed with the repair shop 300 that is capable of performing the repair according to the desired method. An order from the supplier-side system 200 to the repair shop 300 is placed through the Internet. The repair shop 300 having received the order returns the estimated cost for the repair, the time required for the repair, the date on which the repair is started or the like to the supplier-side system 200. These pieces of information are returned to the user-side system 100 by the route which is opposite to that at the time of placing an order, and are notified to the person demanding the inspection in the user terminal 102.

As described above, according to embodiment 6, the presence or absence of an order or orders placed with the repair shop capable of performing the repair by the desired treatment method is sent from the user-side system 100 to the supplier-side system 200, and the order for repairing is placed by the repair shop ordering application 215. Therefore, a series of procedures from the inspection of the car 101 to the placing of order for repairing can be performed by the person who demands the inspection. As a result, there is an effect in that the time to the repairing can be largely shortened.

Embodiment 7

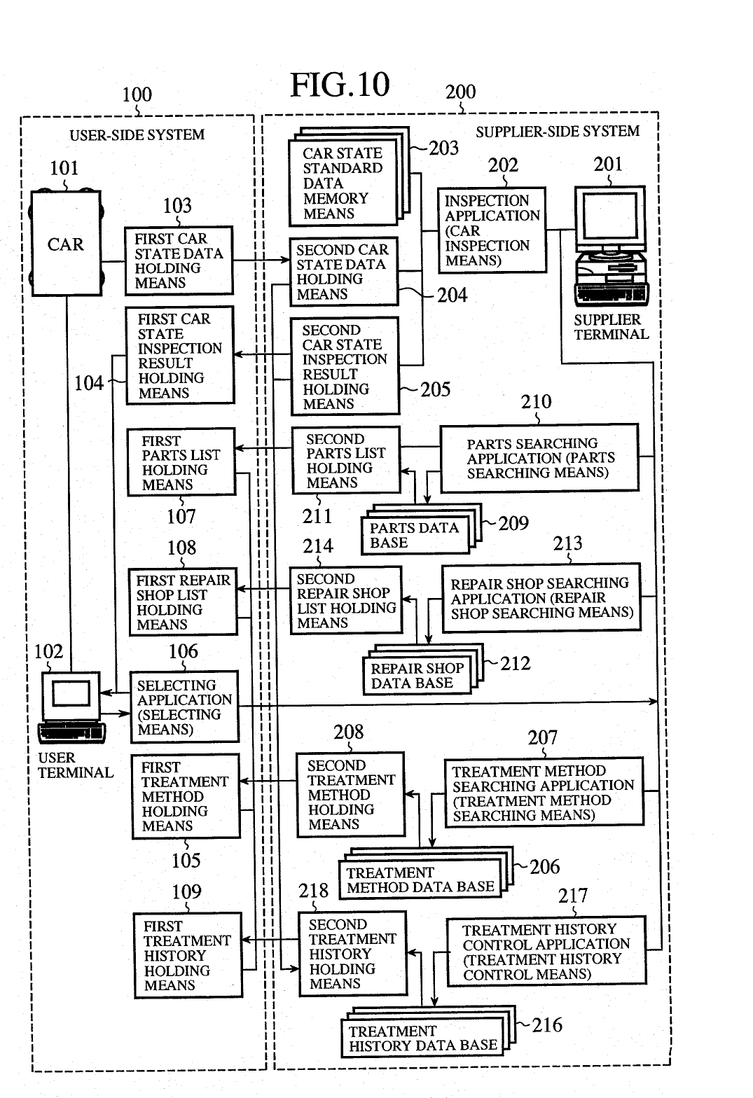

FIG. 10 is a block diagram showing an arrangement of the car inspection system of embodiment 7 according to this invention. The corresponding portions have been assigned the same reference numerals as those in FIGS. 7 and 8, and their explanations are omitted. In the figure, reference numeral 216 is a treatment history data base having recorded therein: car state data and inspection result which are transferred, at the time of inspection of the car 101, from the user-side system 100 to the supplier-side system 200; and treatment history data having recorded therein the personal treatment history data which reflect the treatment method selected by the user-side system 100, or the like. Reference numeral 217 is a treatment history control application as a treatment history control means which searches the treatment history data base 216 to thereby perform the recording and searching of the personal treatment history data. Reference numeral 218 is a treatment history holding means which holds the personal treatment history searched by the treatment history control application 217 and which transfers it to the user-side system 100.

Reference numeral 109 is that treatment history holding means in the user-side system 100 which once holds the personal treatment history data sent from the treatment history holding means 218 of the supplier-side system 200.

A description will now be given of the operation.

In case there exist a plurality of treatment methods to deal with the abnormalities in the car state inspection result of the car 101, the basic operations from the time in which the desired treatment method is selected by the selecting application 106 to the time in which the list of repair shop capable of performing the repair by that treatment method is returned to the user-side system 100 are similar to those as explained in embodiment 5. Therefore, their descriptions are omitted here. Instead, a description is made mainly about the control of the treatment history data by the treatment history control application 217 which has been added to this embodiment.

Whenever the data such as those listed hereinbelow are generated, the treatment history control application 217 records the personal treatment history data by such respective data on the treatment history data base 216, the data in question being: the car state data to be sent, at the time of inspection of the car 101 to be inspected, from the car state data holding means 103 in the user-side system 100 to the car state data holding means 204 in the supplier-side system 200; that car state inspection result in the car state data which is a result of inspection by the inspection application 202 and which is sent from the car state inspection result holding means 205 in the supplier-side system 200 to the car state inspection result holding means 104 in the user-side system 100; the treatment method which is selected by the selecting application 106 in the user-side system 100 based on the car state inspection result and which is sent to the supplier-side system 200; parts to be used; repair shops; or the like.

The personal treatment history data thus recorded in the treatment data base 216 are outputted to the user terminal 102 of the user-side system 100 based on the request for reference from the person demanding the inspection (user). In other words, when a request for reference to the personal treatment history data is made and the request is transferred to the supplier-side system 200, the treatment history control application 217 searches the treatment history data base 216 based on the received request for reference. In this request for reference, it is also possible to designate a required past point of time to make a search for the personal treatment history at that particular point of time. The searched personal treatment history data of the person making the request for reference are held by the treatment history holding means 218 and are also transferred to the user-side system 100 through the Internet.

In the user-side system 100, the personal treatment history data are once held by the treatment history holding means 109 and are outputted to the user terminal 102. By referring to the output to the user terminal 102, the person demanding the inspection is able to know the personal treatment history data, when required, such as the car state data at a desired point of time, the car state inspection result, the treatment method, the parts used, the repair shops, or the like.

As described above, according to embodiment 7, since the personal treatment history data are recorded in the treatment history data base and are outputted to the user terminal 102 depending on the necessity, it is possible to know the information generated in a series of procedures from the inspection of the car 101 to the placing of an order for repairing thereof. When an abnormality has happened, it is possible to determine a treatment method at an early time by making a comparison with the related treatments made in the past. Further, if an abnormality occurs after the treatment, it is possible to utilize the information in making a claim on the car supplier or on the repair shop.

Embodiment 8

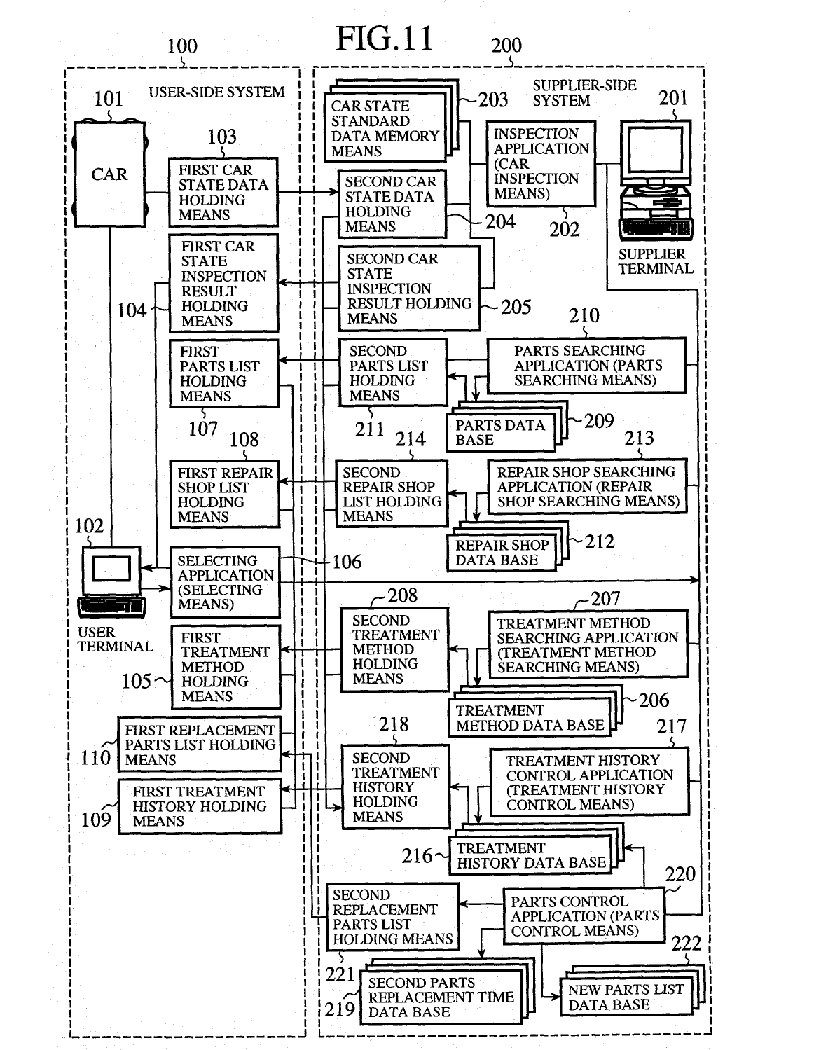

FIG. 11 is a block diagram showing an arrangement of the car inspection system of embodiment 8 of this inanition. The corresponding portions have been assigned the same reference numerals as those in FIG. 10 and their explanations are omitted. In the figure, reference numeral 219 is a parts replacement time data base which is supplied from a parts supplier and which contains a record of replacement time of each of the parts of the car. Reference numeral 220 is a parts control application as a parts control means which controls the replacement time of parts used in the car 101 based on the personal treatment history data of the person demanding the inspection (user) and which prepares a replacement parts list when the time of service (or use) of the parts used in the car 101 to be inspected is longer than the replacement time searched from the parts replacement time data base. Reference numeral 221 is a replacement parts list holding means which holds the replacement parts list prepared by the parts control application 220 and which transmits the list to the user-side system 100. Reference numeral 222 is a new parts list database which has recorded therein new parts lists prepared by the new parts information supplied by the parts manufacturers or the like.

Reference numeral 110 is that replacement parts list holding means in the user-side system 100 which once holds the replacement parts list sent from the replacement parts list holding means 221 in the supplier-side system 200.

A description will now be given of the operation.

When a plurality of treatment methods are present to deal with the abnormalities in the car state inspection result of the car 101, the basic operations from the time in which the desired treatment method is selected by the selecting application 106 to the time in which the parts list by that treatment method and the list of the repair shop capable of repairing by that treatment method are returned to the user-side system 100 and the personal treatment history data are recorded in the treatment history data base 216, are similar to those as described in embodiment 7. Therefore, their descriptions are omitted here. Instead, a description will be made mainly about the operation to control the replacement parts by the parts control application 220.

When a reference to the personal treatment history data is required by the person demanding the inspection (user), the parts control application 220 compares the time of use of the parts in the personal treatment history data to which reference was made with the replacement time data of the parts in question as recorded in the parts replacement time data base 219. As a result, if there are any parts, among the parts used in the car 101 to be inspected, which have been used for a longer period of time than the period in the replacement time data as recorded in the parts replacement time data base 219, a replacement parts list is prepared based on the result of the comparison. If a new product searched from new product information to be supplied by each of the parts manufacturers recorded in the new product list data base 222 is found to be equivalent to the one used in the car 101 to be inspected, then the new product information is described in the replacement parts list as a new product.

The replacement parts list prepared by this parts control application 220 is once held in the replacement parts list holding means 221 and is transferred to the user-side system 100 through the Internet. The user-side system 100 then holds the replacement parts list sent from the supplier-side system 200 in the replacement parts holding means 221 and outputs it to the user terminal 102. By referring to this user terminal 102, the person demanding the inspection is able to know the parts to be replaced in the car 101.

If the parts used in the car 101 have replacement time data showing longer time than those recorded in the parts replacement time data base 219, the data on such parts are contained into the personal treatment history data in the treatment history data base 216 from the parts control application 220.

As described above, according to embodiment 8, there is prepared the list of parts which have been used longer than the parts replacement time as searched from the parts control application 220, and is transferred from the supplier-side system 200 to the user-side system 100. Therefore, the person demanding the inspection is able to know the replacement time of the parts used or to know the new parts information. In conjunction with the online inspection of the car 101, it becomes easier to keep the car 101 always in normal conditions. It is also possible to quickly use the new parts with higher performance.

As described above, the car inspection system according to this invention has the following effects.

The car state data are sent from the user-side system to the supplier-side system and a comparison is then made between the car state data and the car state standard data which are set in advance for the corresponding kind of the car. Therefore, if an access is made from the user-side system to the supplier-side system when one desires an inspection, the car to be inspected is automatically online inspected.

When an abnormality has been found in the car state inspection result, the treatment method is notified from the supplier-side system to the user-side system. Therefore, the car state inspection result and the method of treating the abnormality that only the inspector was able to know so far is immediately known to the person demanding the inspection (user).

A desired treating method is selected from a plurality of treating methods depending on the abnormality and is transferred by the selecting application to the supplier-side system. Therefore, the desired treating method can be selected depending on the treating method and approximate cost of treating or the like. It is thus possible to recognize, within a given range, the treating time and cost which vary with the level of treatment.

Since the repair parts list to suit the desired treating method is sent from the supplier-side system to the user-side system and is outputted to the user terminal, the person demanding the inspection is able to know immediately the part required for the treatment.

Out of the parts list from the supplier-side system, the part to be used is selected by the user-side system and is returned to the supplier-side system. Therefore, the part to be used that only the inspector was so far able to select can be selected by the person demanding the inspection (user). It is thus possible to confirm the cost which varies with the part to be used.

The list of repair shop capable of performing the repairing by the desired treatment method is transferred from the supplier-side system to the user-side system and is outputted to the user terminal. Therefore, it is possible for the person demanding the inspection to immediately know the repair shop with which an order can be placed.

An order is placed with a repair shop by sending the presence or absence of an order or orders placed with a desired repair shop capable of performing the repair in a desired treatment method, from the user-side system to the supplier-side system. Therefore, the person demanding the inspection is able to perform a series of processes from the inspection of the car to the placing of an order for repairing, with a resultant reduction in time to the start of repairing.

The personal treatment history data are recorded in the treatment history data base and outputted to the user terminal when required. It is therefore possible to retrospectively know the information generated in the course of the series of treatments starting with the car inspection to the placing of an order with a repair shop. Therefore, when an abnormality has happened, a comparison may be made with the past related treatments to thereby determine a treatment method earlier.

A list is prepared for the part whose service period (period of actual use) is longer than the replacement period, and the list is transferred from the supplier-side system to the user-side system. Therefore, it is possible for the person demanding the inspection to know personally the time for replacement of the part in use, whereby the car is always kept in a normal state.

It is readily apparent that the above-described car inspection system meets all of the objects mentioned above and also has the advantage of wide commercial utility. It should be understood that the specific form of the invention herein above described is intended to be representative only, as certain modifications within the scope of these teachings will be apparent to those skilled in the art.

Accordingly, reference should be made to the following claims in determining the full scope of the invention.

What is claimed is:

1. A car inspection system comprising a user-side system and a supplier-side system,
said user-side system comprising:
a first car state data holding means for holding car state data of a car to be inspected;
a first car state inspection result holding means for holding a car inspection result of the car;
wherein, upon receipt of a demand for inspection of the car, said user-side system stores the car state data in said first car state data holding means, transfers the demand for inspection together with the car data held in said first car state data holding means, and outputs the car state inspection result held in said first car state inspection result holding means;
said supplier-side system comprising:
a second car state data holding means for holding the car state data transferred from said user-side system;
a car state standard data memory means for storing car state standard data with which is compared the car state data transferred from said user-side system;
a car inspection means for controlling the inspection of the car by comparing the car state data held by said second car state data holding means with the car state standard data stored in said car state standard data memory means;
a second car state inspection result holding means for holding the car state inspection result by said car inspection means,
wherein, upon receipt of a demand for inspection from said user-side system, said supplier-side system starts said car state inspection means to compare the car state data with the car state standard data, holds the car state inspection result in said second car state inspection result holding means, and transmits the car state inspection result held by said second car state inspection result holding means to said user-side system.

2. The car inspection system according to claim 1, wherein said supplier-side system further comprises:
a treatment method data base for storing a treatment method provided for each car inspection result by said car inspection means;
a treatment method searching means for searching said treatment method data base according to the car state inspection result by said car inspection means to thereby select a corresponding treatment method; and
a second treatment method holding means for holding the treatment method selected by said treatment method searching means,
wherein, when the car state inspection result by said car inspection means is found abnormal, said supply-side system transfers the treatment method held by said second treatment method holding means to said user-side system;
said user-side system further comprising:
a first treatment method holding means for holding the treatment method transferred from said supplier-side system,
wherein said user-side system outputs the treatment method held by said first treatment method holding means.

3. The car inspection system according to claim 2, wherein said user-side system further comprises a selecting means for selecting one of treatment methods transferred from said supplier-side system, said user-side system transferring said treatment method selected by said selecting means to said supplier-side system.

4. The car inspection system according to claim 2, wherein said supplier-side system further comprises:
a parts data base for storing data of a part required for each of treatment methods;
a parts searching means which receives the treatment method transferred from said user-side system, searches into said parts data base according to the content of the received treatment method, and prepares a parts list of a required part; and
a second parts list holding means for holding a parts list selected by said parts searching means,
wherein said supplier-side system transfers said parts list held by said second parts list holding means to said user-side system.

5. The car inspection system according to claim 4, wherein said user-side system further comprises:
a first parts list holding means for holding a parts list transferred from said supplier-side system;
a selecting means for selecting a desired part from said parts list held by said first parts list holding means,
wherein said user-side system transfers data of a part selected by said parts list holding means to said supplier-side system.

6. The car inspection system according to claim 2, wherein said supplier-side system further comprises:
a repair shop data base for storing data of a repair shop capable of performing the treatment for each of the treatment methods;
a repair shop searching means which receives the treatment method transferred from said user-side system, searches said repair shop data base according to the content of the received treatment method, and prepares a list of repair shops capable of performing the treatment;
a second repair shop list holding means for holding the list of a repair shop selected by said repair shop searching means;
wherein said supplier-side system transfers the list of repair shops to said user-side system.

7. The car inspection system according to claim 6, wherein said user-side system further comprises:
a first repair shop list holding means for holding the list of repair shops transferred from said supplier-side system;
a selecting means for selecting, out of the repair shop list held by said first repair shop list holding means, a repair shop capable of performing a desired treatment method;
wherein said user-side system transfers the repair shop selected by said selecting means out of said first repair shop list holding means to said supplier-side system;
said supplier-side system further comprising:
a repair shop order means for placing an order with a designated repair shop;
wherein said supplier-side system places an order with the repair shop which is sent from said user-side system and which is selected by said selecting means.

8. The car inspection system according to claim 2, wherein said supplier-side system further comprises:
a treatment history data base for recording, as personal treatment history data, data inclusive of those on the car state, the inspection result, the selected treatment method, the used part, and the repair shop;
a treatment history control means which searches said treatment history data base depending on necessity, and which records and searches the personal treatment history data;
a second treatment history holding means for holding the personal treatment history selected by said treatment history control means;
wherein said supplier-side system records, when said personal treatment history data occur, the data transferred from said user-side system into said treatment history data base and, when a demand from said user-side system is made, searches the personal treatment history data, at a specific point of time, for holding thereof in said second treatment history holding means, and transfers the data to said user-side system;
said user-side system further comprising:
a first treatment history holding means for holding the personal treatment history transferred from said supplier-side system;
wherein said user-side system outputs the personal treatment history data held by said first treatment history holding means.

9. The car inspection system according to claim 8, wherein said supplier-side system further comprises:
a parts -replacement time data base having recorded therein a replacement time of each of parts of the car;
a parts control means for preparing a replacement parts list when a period of using a part is longer than the replacement time searched from said parts replacement time data base;
a second replacement parts list holding means for holding a replacement parts list prepared by said parts control means;
wherein said supplier-side system transfers said replacement parts list held by said second replacement parts list holding means to said user-side system;
said user-side system further comprising:
a first replacement parts list holding means for holding the replacement parts list transferred from said supplier-side system;
wherein said user-side system outputs the replacement parts list held by said first replacement parts list holding means.
